(19) United States
(12) Patent Application Publication
(10) Pub. No.: US 2026/0036780 A1
(43) Pub. Date: Feb. 5, 2026

(54) OPTICAL FIBER CABLE INSTALLATION HAVING AN OPTICAL FIBER CABLE DISPOSED IN A TRENCH AND RELATED METHOD

(71) Applicant: CORNING RESEARCH & DEVELOPMENT CORPORATION, Corning, NY (US)

(72) Inventors: David Montalion Dupuis, Cedar Park, TX (US); Sean Gutierrez, Round Rock, TX (US); Cary Alan Kipke, Pflugerville, TX (US); Donald Kent Larson, Cedar Park, TX (US)

(21) Appl. No.: 19/353,984

(22) Filed: Oct. 9, 2025

Related U.S. Application Data
(63) Continuation of application No. PCT/US2024/025080, filed on Apr. 18, 2024.
(60) Provisional application No. 63/465,275, filed on May 10, 2023.

(51) Int. Cl. G02B 6/50

(52) U.S. Cl. CPC G02B 6/504

(57) ABSTRACT

An installation includes pavement having a top surface and a trench formed in the pavement. The trench includes a first region having a first width and a second region having a second width that is less than the first width. The first region is closer to the top surface than the second region. An optical fiber cable is disposed in the second region of the trench. A tape is disposed in the first region of the trench and covers the optical fiber cable. The tape has an upper surface and edges along a length thereof. A sealant is applied along the length of the tape, and the sealant covers the edges of the tape and at least a portion of the upper surface of the tape. The top surface of the pavement defines a plane, and the upper surface of the tape is recessed from the plane.

### CROSS-REFERENCE TO RELATED APPLICATION

This application is a continuation on International Patent Application No. PCT/US2024/025080, filed on April 18, 2024, which claims the benefit of priority of U.S. Provisional Application No. 63/465,275, filed on May 10, 2023, the content of which is relied upon and incorporated herein by reference in its entirety.

### BACKGROUND

The disclosure relates generally to an optical fiber cable installation and more particularly to an installation in which the optical fiber cable is disposed in a trench and covered with a tape. Optical fiber cables are deployed in a variety of different installations. For example, aerial cables may be strung across utility poles, and underground optical fiber cables may be carried in ducts. For running an optical fiber cable to a subscriber, only a lower fiber count cable is needed, and one way to provide the cable to the subscriber is to run the cable along or across a roadway in a trench. However, running an optical fiber cable over a roadway requires shutting down of traffic, and thus, quick and secure methods of installation are desirable.

### SUMMARY

According to an aspect, embodiments of the disclosure relate to an installation. The installation includes pavement having a top surface and a trench formed in the pavement. The trench includes a first region having a first width and a second region having a second width that is less than the first width. The first region is closer to the top surface than the second region. An optical fiber cable is disposed in the second region of the trench. A tape is disposed in the first region of the trench and covers the optical fiber cable. The tape has an upper surface and edges along a length thereof. A sealant is applied along at least a portion of the length of the tape, and the sealant covers the edges of the tape and at least a portion of the upper surface of the tape. The top surface of the pavement defines a plane, and the upper surface of the tape is recessed from the plane.

According to another aspect, embodiments of the disclosure relate to an installation. The installation includes pavement having a top surface and a trench formed in the pavement. An optical fiber cable is disposed in the trench, and a sealant fills at least a portion of the trench such that the sealant is flush with or raised above the top surface of the pavement. The top surface of the pavement includes a first surface texture, and the sealant has a second surface texture embossed to match or approximate the second surface texture.

According to a further aspect, embodiments of the disclosure relate to a method. In the method, a trench in pavement is filled with a sealant. The trench contains an optical fiber cable, and sealant covers the optical fiber cable and is flush with or raised above a top surface of the pavement. The top surface has a first surface texture. Further, in the method, an embossing roll is rolled over the sealant to create a second surface texture in the sealant. The embossing roll includes a roll surface having formed therein a negative of the second surface texture. The second surface texture is configured to match or approximate the first surface texture.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts an installation of an optical fiber cable in a trench covered by a tape and mechanically restrained using a sealant, according to an exemplary embodiment;

FIGS. 2A and 2B are before and after photographs of a tape in a trench with sealant and without sealant exposed to static tire rotation, according to exemplary embodiments;

FIG. 3 depicts an embodiment of an optical fiber cable in a trench covered by a tape having a reduced width relative to the width of the trench to provide additional area for the sealant to bond to the trench, according to an exemplary embodiment;

FIG. 4 depicts sealant used to mechanically restrain ends of adjacent tapes to prevent opening of a butt seam, according to an exemplary embodiment;

FIG. 5 depicts an installation in which the sealant forms a dome over the tape, according to an exemplary embodiment;

FIG. 6 depicts an installation in which the sealant is flush with the top surface of the pavement, according to an exemplary embodiment;

FIG. 7 depicts an installation with a stepped trench filled with sealant, according to an exemplary embodiment;

FIG. 8 depicts an embossing roller for forming a surface texture in the sealant, according to an exemplary embodiment;

FIG. 9 depicts an installation in which an optical fiber cable is disposed in a trench and covered with sealant that has been texturized to match the texture of the pavement, according to an exemplary embodiment;

FIG. 10 depicts another installation in which an optical fiber cable is disposed in a T-trench and covered with sealant that has been texturized to match the texture of the pavement, according to an exemplary embodiment; and

FIG. 11 depicts a longitudinal cross-sectional view of an installation in which the trench is formed through a region of pavement having defects and the optical fiber cable is carried in a conduit, according to an exemplary embodiment.

### DETAILED DESCRIPTION

Referring generally to the figures, various embodiments of in-road optical fiber cable installations are provided. As will be discussed more fully below, embodiments of the installation include an optical fiber cable laid in a trench and covered by a tape, and in certain areas where the tape is expected to be vulnerable to disruption by vehicle tires, the tape is mechanically restrained into place using a sealant applied along edges of the tape. In one or more embodiments, the sealant can be applied over the tape as well such that the sealant is flush with the pavement or raised above the pavement. Advantageously, the sealant mechanically restrains the tape from peeling from the trench when exposed to shear forces, such as from static tire rotations, or tensile forces, such as from stress relaxation after application of the tape. Further, embodiments of the present disclosure relate to a sealant that can be embossed with a surface texture that matches or approximates the surface texture of the pavement to mask the optical fiber cable installation. Exemplary embodiments of the in-road optical fiber cable installation and methods of forming same will be described in greater detail below and in relation to the figures provided herewith, and these exemplary embodiments are provided by way of illustration, and not by way of limitation.

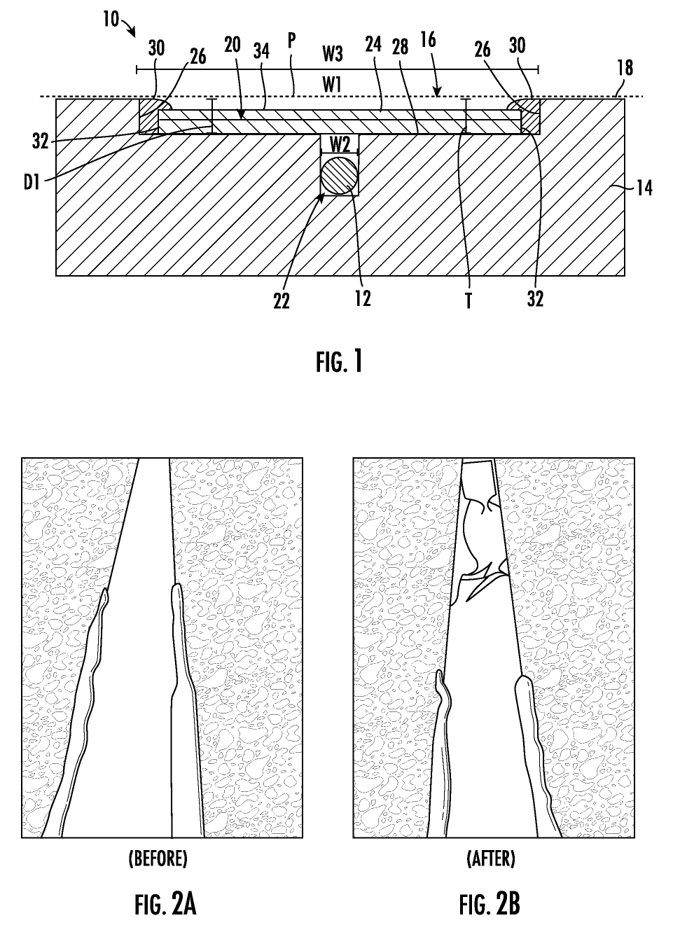

FIG. 1 depicts an embodiment of an installation 10 of an optical fiber cable 12 disposed in pavement 14. The pavement 14 may be any of a variety of pavement types, including for example concrete and asphalt, and as will be discussed more fully below, the installation 10 is particularly suitable for use in high traffic areas, especially where vehicles are expected to make static wheel turns (such as parking lots, driveways, adjacent to curbs where parallel parking is performed, etc.) or accelerate from a stop.

In one or more embodiments, the installation 10 includes a trench 16 formed in the pavement 14. The pavement 14 has a top surface 18 defining a plane P of the pavement 14, and the trench 16 is recessed from the plane P defined by the top surface 18. In one or more embodiments, the trench 16 is a T-shaped trench having a first region 20 and a second region 22. The first region 20 has a first width W1, and the first region 20 is positioned relatively closer to the plane P of the top surface 18 than the second region 22. The second region 22 has a second width W2, and the second region 22 is positioned relatively farther from the plane P of the top surface 18 than the second region 22. The second width W2 is less than the first width W1.

In one or more such embodiments in which the trench 16 is a T-shaped, the optical fiber cable 12 is positioned within the second region 22 of the trench 16. In such embodiments, the second width W2 of the second region 22 of the trench 16 may be selected to be slightly wider than the width of the optical fiber cable 12. In one or more embodiments, the second width W2 of the second region 22 is 25% to 50% larger than the width of the optical fiber cable 12 to allow the optical fiber cable 12 to move freely for relief of axial strains. In one or more embodiments, the second width W2 is up to 0.5 inches. The optical fiber cable 12 can be any of a variety of types of optical fiber cables 12, depending on the requirements of the installation 10. For example, to provide access to a subscriber, the optical fiber cable 12 may include only a single optical fiber and have cross-sectional dimensions of 3 mm x 6.6 mm (e.g., ROC^{TM} drop cable, available from Corning Incorporated, Corning, NY). In other installations 10, the optical fiber cable 12 may contain up to 72 optical fibers and have a diameter of up to 4.5 mm (e.g., MiniXtend® HD cable, available from Corning Incorporated, Corning, NY). In addition, a microduct may be installed in the second region 22 of the trench 16, and the optical fiber cable 12 may pulled or blown into the microduct (e.g., 10mm OD x 8mm ID MicroDuct, available from Dura-Line Corporation, Knoxville, Tennessee).

During installation, the optical fiber cable 12 is laid in the second region 22 of the trench 16, and a tape 24 is placed over the optical fiber cable 12 in the first region 20 of the trench 16. In particular, the first region 20 of the trench 16 has sidewalls 26 and a floor 28. The second region 22 of the trench 16 is formed through the floor 28, and the tape 24 is positioned within the first region 20 of the trench between the sidewalls 26 and attached to the floor 28, covering the second region 22 and thus optical fiber cable 12.

As used herein, “tape” may refer to an adhesive tape or to a long strip of material. In either case, the tape 24 has a third width W3 that is less than the first width W1 of the first region 20 of the trench 16. For example, in an embodiment, the first width W1 of the first region 20 of the trench 16 is about 2.25 inches, and the third width W3 of the tape 24 is about 2 inches or less. Providing this buffer between the first width W1 of the first region 20 of the trench 16 and the tape 24 facilitates application of the tape 24 within the trench 16. That is, if the widths of the trench 16 and the tape 24 were to match, it would be difficult for an installer to quickly position the tape 24 within the trench 16.

In the embodiment described in relation to FIG. 1, the tape 24 is an adhesive tape, in particular a pressure sensitive adhesive tape. The tape 24 adheres to the floor 28 of the first region 20 of the trench 16. Various commercially available adhesive tapes are suitable for use in embodiments of the installation, such as Series 300 and Series 400 Permanent Preformed Polymer Tapes (available from Advance Traffic Markings, Weldon, North Carolina). In one or more embodiments, the tape 24 includes a rough upper surface that contains grit particles, such as spherical aluminum oxide particles. In one or more such embodiments, the grit particles have a unimodal distribution or a bimodal distribution of particle sizes in which the mode or modes are in a range of 0.010 inches to 0.025 inches (e.g., bimodal distribution of 0.012 inches grit particles and 0.020 inches grit particles). In one or more embodiments, a primer may be applied to the trench 16 to enhance adhesion between the tape 24 and the floor 28 of the first region 20 of the trench 16.

The tape 24 has a thickness T measured perpendicular to the third width W3. The sidewalls 26 of the first region 20 of the trench 16 define a first depth D1 of the first region 20. In one or more embodiments, the thickness T of the tape 24 is less than the first depth D1 of the first region 20 of the trench 16. In this way, the tape 24 is recessed from the top surface 18 of the pavement 14. In one or more embodiments, the first depth D1 of the first region 20 of the trench 16 is at least 0.1 inches, at least 0.15 inches, or at least 0.2 inches. In one or more embodiments, the first depth D1 of the first region 20 of the trench 16 is up to 0.3 inches. In one or more embodiments, the thickness T of the tape 24 is 0.1 inches or less, 0.08 inches or less, or 0.06 inches or less. In one or more embodiments, the thickness T of the tape 24 is at least 0.005 inches. In one or more embodiments, the difference between the first depth D1 of the first region 20 of the trench 16 and the thickness T of the tape 24 is at least 0.05 inches, at least 0.08 inches, or at least 0.1 inches. In one or more embodiments, the difference between the first depth D1 of the first region 20 of the trench 16 and the thickness T of the tape 24 is up to 0.2 inches. Applicant has found that recessing the tape 24 from the top surface 18 of the pavement 14 helps to reduce the wear and damage experienced by the tape 24.

Notwithstanding, in certain high traffic areas where vehicle tires apply static angular rotation (such as parking lots), the vehicle tire can grab the tape 24 in the trench 16 and pull the tape 24 from the floor 28 of the first region 20 of the trench 16, potentially allowing water, rocks, and other debris to fill the second region 22 of the trench 16. Applicant has found that this issue can be addressed by applying a sealant 30 at least along edges 32 of the tape 24 in such high traffic areas.

As shown in FIG. 1, the sealant 30 fills the gap between the edges 32 of the tape 24 and the sidewalls 26 of the first region 20 of the trench 16. Additionally, the sealant 30 covers at least a portion of an upper surface 34 of the tape 24. The sealant 30 strongly adheres to the pavement 14, including the sidewalls 26 and floor 28 of the first region 20 of the trench 16. In one or more embodiments, the sealant 30 is thermosetting or thermoplastic material.

In one or more embodiments, the sealant 30 is a thermosetting material comprised of two or more parts that cure in place after application. In one or more such embodiments, the thermosetting material is applied at ambient temperature (i.e., the thermosetting material is not heated during application). In one or more embodiments, the thermosetting material is polyester-based. An example of a thermosetting material suitable for use according to embodiments of the present disclosure is Bondo® Traffic, P-606 Flexible Loop Sealer with Hardener (available from 3M Company, Maplewood, Minnesota).

In one or more embodiments, the sealant 30 is a thermoplastic material. In one or more embodiments, the thermoplastic material is heated during application such that the thermoplastic material is molten during application. In one or more embodiments, the thermoplastic material is asphalt-based. An example of a thermoplastic material suitable for use according to embodiments of the present disclosure is Parking Lot Sealant Type 2, Part No. 34200 (available from Crafco, Inc., Chandler, Arizona).

In one or more embodiments, the sealant 30 is selectively applied along the length of the tape 24 in areas where vehicles are expected to cause damage to or disrupt the tape 24. For example, the trench 16 may run along a roadway and turn into a driveway and parking lot, and the sealant 30 may only be applied in the driveway or certain parts thereof. That is, in regions where a vehicle tire is expected to apply a static angular rotation to the tape 24 or to apply dynamic straight-line acceleration forces to the tape 24, such as in a turn-in to the driveway or in a parking space of the parking lot, the edges 32 of the tape 24 may be sealed with the sealant 30. Situations in which a vehicle is expected to apply a static angular rotation include such actions as preparing for a turn, parallel parking, pulling out of a parallel parking space, and straightening tires in a parking space, amongst others in which the vehicle is substantially stationary and the tires are rotated. Situations in which a vehicle is expected to apply dynamic straight-line acceleration include such actions as accelerating out of a driveway, from a stoplight, and out of a parking space, amongst others. Thus, in one or more embodiments, the sealant 30 is applied along the length of the tape 24 where vehicles are expected to start motion (turning and/or accelerating) from a stop.

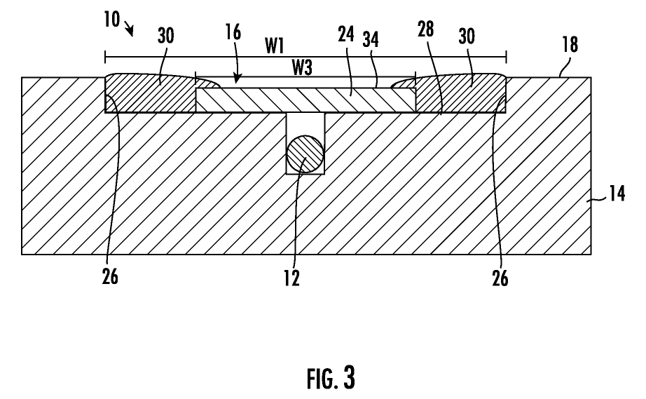

FIGS. 2A and 2B depict before and after images, respectively, for a section of tape without sealant and a section of tape with sealant that were exposed to a static angular rotation of a vehicle tire. In the test, a 2.5 inch wide T-trench was formed in pavement. A primer was applied to the trench, and a 2 inch wide pressure sensitive road adhesive tape was applied in the trench. The sidewalls of the first region of the trench had a depth of 0.180 inches, and the tape had a thickness of 0.060 inches. Thus, the tape was recessed below the top surface of the pavement by 0.120 inches. Sealant (Bondo® Traffic, P-606 Flexible Loop Sealer with Hardener) was applied along both edges of a section of the tape applied to the trench, and another section was left without sealant. The tape prior to testing, including the section with sealant and without sealant, can be seen in FIG. 2A.

After the sealant cured, a truck (Ford F-150) was parked perpendicular to the tape axis with one tire on the tape in the sealant section and with one tire on the tape in the section without sealant. Starting from a straight, center position, the tires were rotated until reaching the left lock, rotated to the right lock, and then returned to center. The tape after testing is shown in FIG. 2B. From a comparison of FIGS. 2A and 2B, it can be seen that the section of tape having sealant is undisturbed, whereas the section without sealant experienced significant displacement of the tape.

The results of the test were surprising and unexpected to the Applicant. In particular, the sealant is configured to form a strong bond with the pavement, but the sealant does not form a strong bond with the tape. The tape used was a pressure sensitive adhesive, and the upper surface of the tape had a release coating that allows the tape to be unspooled without the layers sticking to each other. Because of the release coating, it was not expected that the sealant would attach strongly to the upper surface of the tape, and indeed, the peel strength between the tape and the sealant did not seem high. However, the tape included grit that made the upper surface of the tape rough, and Applicant surmises that, unexpectedly, the sealant mechanically restrained the tape within the trench against the shearing force imparted by the static rotation of the tire.

FIG. 3 depicts another embodiment of the installation 10 in which the third width W3 of the tape 24 is further decreased relative to the first width W1 of the first region 20 of the trench 16. By decreasing the third width W3 of the tape 24, the surface of the floor 28 for bonding to the sealant 30 is increased, further anchoring the sealant 30 to the pavement 14. The sealant 30 still covers at least a portion of the upper surface 34 of the tape 24, interacting with the upper surface 34 to provide the mechanical restraint of the tape.

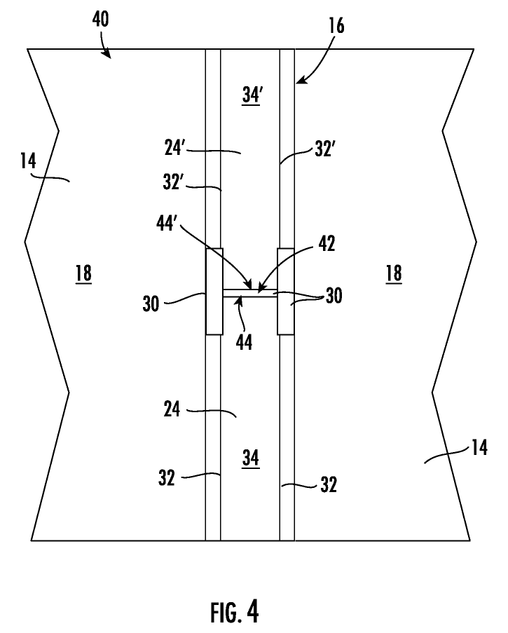

FIG. 4 depicts another embodiment of an installation 40 for which sealing of the edges 32 of the tape 24 is advantageous. The length of a trench 16 may be much longer than the length of a roll of tape 24 applied in the trench 16, and thus, multiple rolls of tape 24 may be used with successive tapes 24 abutting each other. FIG. 4 depicts a butt seam 42 between a first tape 24 and a second tape 24’. During application, the tapes 24, 24’ are under tension, and after application, there is residual tension in the tapes 24, 24’. Over time, the tapes 24, 24’ will try to relax to relieve the tension, opening the butt seam 42. In certain circumstances, the tension in the tapes 24, 24’ could be high enough to open a gap of up to 1 inch in the butt seam 42. Such large gaps can allow the trench 16 to fill with sediment, locking the optical fiber cable 12 from axial movement to relieve stresses. This can in certain circumstances contribute to buckling of the optical fiber cable 12 and to lifting of the tape 24, 24’. However, in installation 40, sealant 30 is used to substantially diminish or prevent the opening of the butt seam 42 that occurs from stress relaxation in the tapes 24, 24’.

As shown in FIG. 4, the first tape 24 has a first end 44, and the second tape 24’ has a second end 44’. The ends 44, 44’ meet to form the butt seam 42. In one or more embodiments, sealant 30 is applied to the edges 32, 32’ of the tapes 24, 24’ upstream and downstream of the butt seam 42. In one or more embodiments, the sealant 30 is applied to the edges 32, 32’ at least 6 inches upstream and downstream of the butt seam 42, and in one or more embodiments, the sealant 30 is applied to the edges 32, 32’ up to 12 inches upstream and downstream of the butt seam 42. In one or more embodiments, the sealant 30 is also applied across the butt seam 42, covering the ends 44, 44’ of the tapes 24, 24’.

To determine the effectiveness of the sealant 30 on preventing opening of the butt seam 42, Applicant created a butt seam 42 between two tapes 24, 24’ in a trench 16. The tapes 24, 24’ were laid with a tension of 10 pounds, and after laying the tapes 24, 24’, the sealant 30 was applied along the edges 32, 32’ in the trench 16. After 20 days, the butt seam 42 remained tight, indicating that opening of the butt seam 42 was substantially diminished or prevented. Applicant expects that gaps in the butt seam 42 can be reduced by 2/3 by applying sealant 30 along the edges 32, 32’ of the tapes 24, 24’ in the trench 16 and across the butt seam 42.

In the embodiments depicted in FIGS. 1-4, the sealant 30 was applied only along the edge 32 of the tape 24 and covered just a portion of the upper surface 34. However, in one or more other embodiments, the sealant 30 can be applied over the entire upper surface 34 of a section of the tape 24 as well as shown in FIGS. 5-7.

FIG. 5 depicts an embodiment in which the sealant 30 is applied over and along the tape 24 and over at least a portion of the top surface 18 of the pavement 14, creating a dome 46 that covers the trench 16 and extends above the plane P defined by the top surface 18. In one or more embodiments, the sealant 30 has a thickness of up to about 0.25 inches. In order to create the dome 46, a thermoplastic sealant applied at elevated temperature may be used in one or more embodiments.

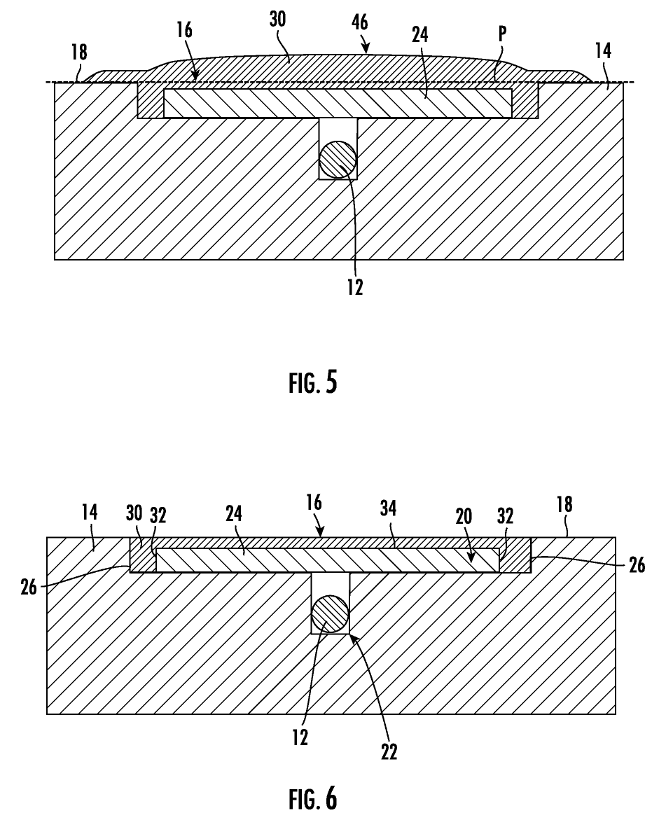

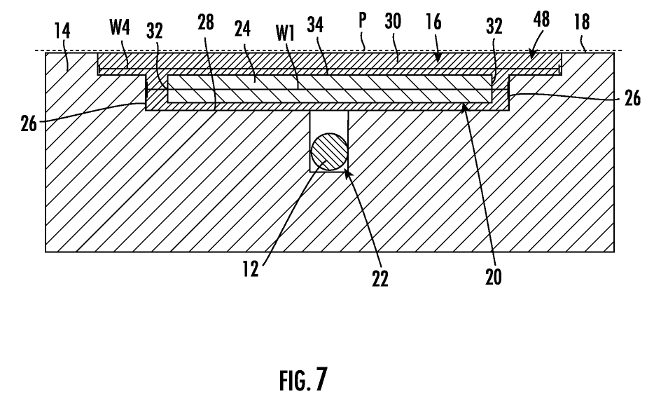

FIG. 6 depicts an embodiment in which the sealant 30 is applied over and along the tape 24 such that the trench 16 is filled substantially flush with the top surface 18 of the pavement 14. As shown in FIG. 6, the sealant 30 fills the gap between the sidewalls 26 of the first region 20 of the trench 16 and the edges 32 of the tape 24, and the sealant 30 covers the upper surface 34 of the tape. In one or more embodiments, a multi-part, ambient-cure thermosetting sealant 30 may be used to create the sealant surface flush with the top surface 18 of the pavement 14.

In the embodiments of FIGS. 5 and 6, the sealant 30 covering the tape 24 provides an extra level of protection against wear and puncture damage from, e.g., vehicles. Additionally, as mentioned above, the upper surface 34 of the tape 24 has a release coating (e.g., a silicone coating) that provides low adhesion. In this way, the sealant 30 is mechanically engaged with upper surface 34 of the tape 24, but shear forces applied to the sealant 30 (e.g., from static tire rotation) are not necessarily transmitted to the tape 24. That is, because the sealant 30 in the embodiments of FIGS. 5 and 6 is at or above the top surface 18 of the pavement, the sealant 30 will routinely interact with the tires of a vehicle, and while the strong bond between the sealant 30 and the pavement 14 is not likely to be affected by such interaction, it is desirable that forces from such interaction are not transmitted to the tape 24, which is more susceptible to shear from tire rotations.

FIG. 7 depicts another embodiment in which the sealant 30 covers the upper surface 34 of the tape 24. In one or more embodiments, the trench 16 includes a third region 48 disposed between the first region 20 and the plane P defined by the top surface 18 of the pavement. The third region 48 has a fourth width W4 that is wider than the first width W1, creating a stepped or tiered trench 16. When the sealant 30 is applied, the sealant 30 fills the gap between the edges 32 of the tape 32 and the sidewalls 26 of the first region 20, covers the upper surface 34 of the tape 24, and fills the third region 48. In such embodiments, the sealant 30 may be flush with the top surface 18 of the pavement 14 as shown in FIG. 7, or the sealant 30 may be domed above the plane P defined by the top surface 18 of the pavement 14.

As mentioned above, “tape” as used herein may also refer to a long strip of material, and in the embodiment reflected in FIG. 7, the tape 24 may be a mesh scrim or a permeable membrane having perforations. That is, the tape 24 can be selected to be a material that allows the sealant 30 to flow through the tape 24 such that the sealant 30 fulfills the adhesive function. Thus, instead of the tape 24 adhering itself to the floor 28 of the first region 20 of the trench 16, the sealant 30 adheres the scrim or permeable membrane tape 24 to the floor 28 of the first region 20 of the trench 16. According to such embodiments, the tape 24 acts as a reinforcement for the sealant 30.

As discussed above, the sealant 30 is selectively applied along the length of the trench 16 where the tape 24 is expected to experience forces that may cause disruption, edge lifting, or separation of the tape 24. In the embodiment of FIG. 7, an adhesive tape 24 can be used for large sections of the trench 16, and in selected areas where the sealant 30 is applied, the non-adhesive scrim or permeable membrane tape 24 can be used.

In the embodiments reflected in FIGS. 5-7, the sealant 30 is flush with or extends above the top surface 18 of the pavement 14. In such embodiments, it may be desirable to texture the sealant 30 to match the texture of the pavement 14. That is, the pavement 14 may have various rough or textured top surfaces 18, such as a chipseal texture, an asphalt texture, concrete striations, brush finish, aggregate finish, etc. Further, the pavement 14 may include various pedestrian markings or traction features, such as a waffle texture, ribs, raised or depressed dimples, etc. According to embodiments of the present disclosure, the sealant 30 can be molded to match or approximate the texture of the surrounding pavement 14.

According to embodiments of the present disclosure, a matching or approximate texture can be molded into the sealant 30 using an embossing roller 50 as shown in FIG. 8. In such embodiments, a mold may be taken of the area of the top surface 18 of the pavement 14 adjacent to the trench 16, and the mold may be transferred to an embossing roller 50. Alternatively, a variety of standard embossing rollers 50 approximating the textures of various top surfaces 18 of pavements 14 may be available. By “approximating,” it is meant that the surface texture of the pavement 14 and the surface texture of the sealant 30 have the same general pattern even if some features or dimensions are not the same (e.g., both the pavement 14 and sealant 30 have a waffle texture but with different grid spacing). As shown in FIG. 8, the embossing roller 50 has a negative of a waffle texture so as to apply the waffle texture to the sealant 30. In one or more embodiments, the embossing roller 50 includes a surface 52 made of a low-surface energy material to avoid sticking to the curing or solidifying sealant 30. In one or more such embodiments, the surface 52 is made from polytetrafluoroethylene (PTFE) or polyethylene (PE), among other possibilities.

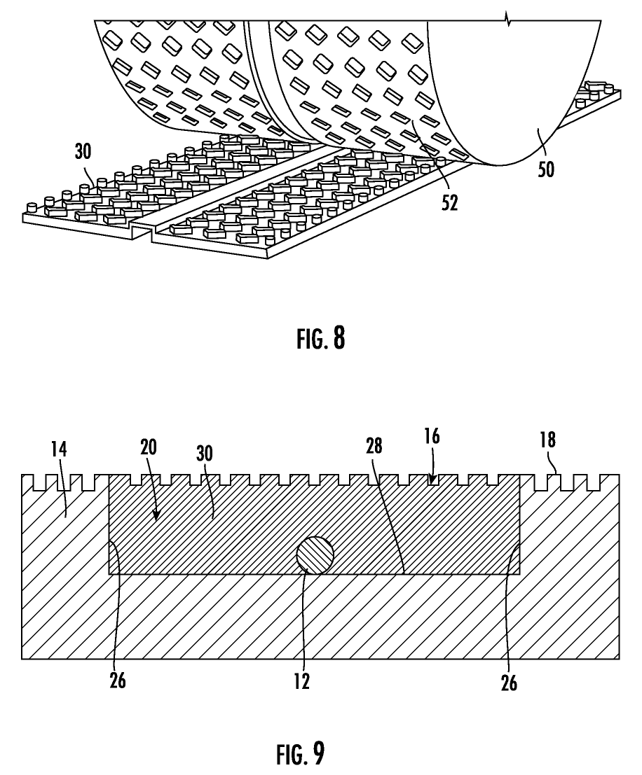

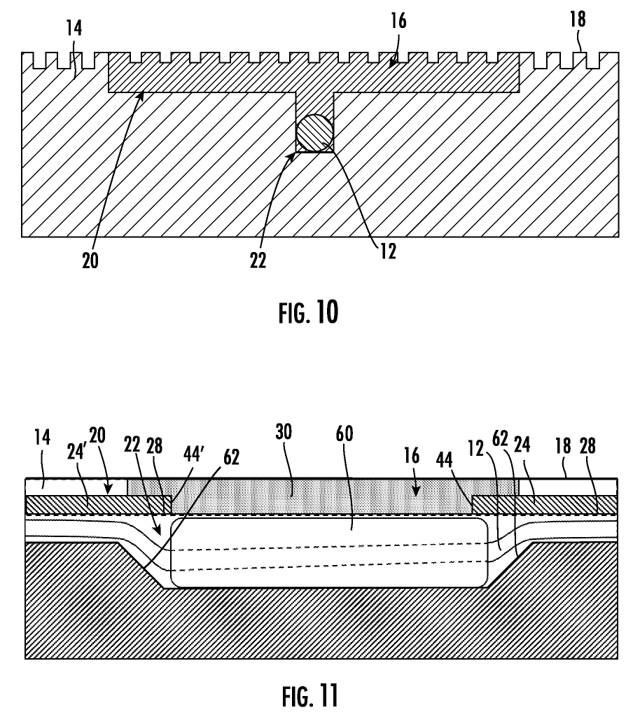

Such texturing can be applied to other trench types as shown in FIGS. 9 and 10. In FIG. 9, the trench 16 includes a single region 20 having sidewalls 26 and a floor 28. The optical fiber cable 12 is positioned within the trench 16 on the floor 28 of the trench 16, and the sealant 30 fills the trench 16. As the sealant 30 cures, the embossing roller 50 is rolled over the sealant 30 to texturize the sealant 30 to match or approximate the texture of the top surface 18 of the pavement 14. FIG. 10 depicts a T-shaped trench 16 having a first region 20 and a second region 22 as discussed above. The optical fiber cable 12 is positioned in the second region 22, and the sealant 30 is applied in the trench 16 to cover the optical fiber cable 12 in the second region 22 and filling the first region 20. The embossing roller 50 is rolled over the sealant 30 to texturize the sealant 30 to match or approximate the texture of the top surface 18 of the pavement 14. Thus, according to embodiments of the present disclosure, the sealant 30 includes a patterned surface texture, such as a chipseal texture, an asphalt texture, striations, brushed finish, aggregate finish, a waffle texture, ribs, or raised or depressed dimples, amongst other possibilities.

The thermoplastic or thermosetting sealants described above are suitable for use in creating the texturized surface. Additionally, the sealant 30 can be a cure-in-place urethane sealant. A commercially available urethane sealant suitable for use according to embodiments of the present disclosure is Scotchkote Urethane Elastomer 60 EG 533 (available from 3M Company, Maplewood, Minnesota).

FIG. 11 depicts another embodiment in which the optical fiber cable 12 traverses a disruption in the pavement 14. For example, the trench 16 may need to pass through a region of pavement 14 having defects, such as cracks, dislodged pavement, or potholes. While it is desirable that the pavement 14 be repaired to remove such defects prior to installation of the optical fiber cable 12, it is not always possible to wait for such repairs to be made, especially if time is of the essence. To traverse such regions of defects in the pavement 14 according to embodiments of the present disclosure, the optical fiber cable 12 is positioned within a conduit 60 in the trench 16 and covered with sealant 30.

As shown in FIG. 11, the optical fiber cable 12 runs in the second region 22 of the trench 16 until reaching the region of defects in the pavement 14. The optical fiber cable 12 is covered by the tape 24 within the trench 16 until that point. Thereafter and throughout the region of defects in the pavement 14, the second region 22 of the trench 16 is deepened and widened over a section to accommodate the conduit 60. In one or more embodiments, the trench 16 may be deepened from, e.g., 0.5 inches to 1.5 inches and widened from, e.g., 0.25 inches to 0.5 inches. Such a section of the second region 22 of the trench 16 can accommodate a conduit 60, such as VDC1 conduit available from Teraspan Networks Inc. (Burnaby, British Columbia, Canada), which has dimensions of 1.04 inches by 0.41 inches. In widening and deepening the second region 22 of the trench, transition regions 62 are formed where the second region 22 deepens at the start of the defect region of the pavement 14 and where the second region 22 ascends to the standard depth after the defect region of the pavement 14.

After the widened and deepened section of the second region 22 of the trench 16 is formed, the debris is cleaned from the second region 22, and the conduit 60 is provided around the optical fiber cable 12. The above-mentioned conduit 60, VDC1, is a clamshell conduit having a two-piece construction that snaps around the optical fiber cable 12. After the conduit 60 is provided around the optical fiber cable 12, the conduit 60 and the optical fiber cable 12 are placed in the second region 22 of the trench 16. As discussed above, the tape 24, 24’ is attached to the floor 28 of the first region 20 of the trench 16 over the optical fiber cable 12 upstream and downstream of the defect region of the pavement 14.

In the defect region, the conduit 60 containing the optical fiber cable 12 is covered with sealant 30. In particular, the sealant 30 covers the ends 44, 44’ of the tapes 24, 24’ and the defect region of the pavement 14. In one or more embodiments, the sealant 30 fills the trench 16 such that the sealant 30 is substantially flush with the top surface 18 of the pavement 14. Any of a variety of sealants 30 can be used to fill the trench in the defect region, including the above-mentioned Bondo® Traffic, P-606Flexible Loop Sealer with Hardener; Parking Lot Sealant Type 2, Part No. 34200; or Scotchkote Urethane Elastomer 60 EG 533. Another commercially available sealant that is suitable for use according to the present disclosure is Q-Seal^{TM}295-P606 (available from H.B. Fuller Company, Vadnais Heights, Minnesota).

The sealant 30 used may be applied at an elevated temperature. In such embodiments, the optical fiber cable 12 can be protected from the elevated temperature by wrapping the optical fiber cable 12 in the defect region with silicone self-fusing tape.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article "a" is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An installation, comprising
pavement having a top surface;
a trench formed in the pavement, the trench comprising a first region having a first width and a second region having a second width that is less than the first width, and the first region being closer to the top surface than the second region;
an optical fiber cable disposed in the second region of the trench;
a tape disposed in the first region of the trench and covering the optical fiber cable, the tape having an upper surface and edges along a length thereof; and
a sealant applied along at least a portion of the length of the tape, the sealant covering the edges of the tape and at least a portion of the upper surface of the tape;
wherein the top surface of the pavement defines a plane and wherein the upper surface of the tape is recessed from the plane.

2. The installation of claim 1, wherein at least a portion of the upper surface of the tape remains exposed between strips of sealant applied along the edges of the tape.

3. The installation of claim 1, wherein the sealant covers the upper surface of the tape and is substantially flush with the top surface of the pavement.

4. The installation of claim 3, wherein the sealant comprises a first surface texture configured to match or approximate a second surface texture of the top surface of the pavement.

5. The installation of claim 1, wherein the sealant covers the upper surface of the tape and forms a dome that extends above the plane defined by the top surface of the pavement.

6. The installation of claim 1, wherein the tape has a third width defined by the edges of the tape, the third width being less than the first width of the first region of the trench such that a gap is provided between each edge of the tape and a respective sidewall of the first region, and wherein the sealant fills the gap.

7. The installation of claim 6, wherein the gap between each edge of the tape and the respective sidewall is in a range from 0.1 inches to 0.5 inches.

8. The installation of claim 1, wherein the sealant is a thermoplastic sealant.

9. The installation of claim 8, wherein the thermoplastic sealant is asphalt-based.

10. The installation of claim 1, wherein the sealant is a thermosetting sealant.

11. The installation of claim 10, wherein the sealant is polyester-based or polyurethane-based.

12. The installation of claim 1, wherein the trench comprises a third region having a fourth width, the fourth width being greater than the first width of the first region, wherein the first region is disposed between the second region and the third region, and wherein the sealant fills the third region.

13. The installation of claim 12, wherein the tape comprises a scrim or a permeable membrane and wherein the sealant flows through the tape.

14. The installation of claim 1, further comprising a second tape, wherein a first end of the tape abuts a second end of the second tape to form a butt seam and wherein the sealant is disposed along respective edges of the first tape and of the second tape and disposed across the butt seam.

15. The installation of claim 1, wherein the trench comprises a first section of the second region and a second section of the second region, wherein the second section is deeper and wider than the first section, wherein the optical fiber cable is surrounded by a conduit in the second section, wherein the tape ends over the first section and no tape is provided over the conduit in the second section, and wherein sealant fills the first region of the trench over the conduit.

16. A method, comprising:
filling a trench in pavement with a sealant, the trench containing an optical fiber cable and sealant covering the optical fiber cable and being flush with or raised above a top surface of the pavement, the top surface having a first surface texture; and
rolling an embossing roll over the sealant to create a second surface texture in the sealant, the embossing roll comprising a roll surface having formed therein a negative of the second surface texture;
wherein the second surface texture is configured to match or approximate the first surface texture.

17. The method of claim 16, wherein the roll surface comprises polytetrafluoroethylene or polyethylene.

18. The method of claim 16, wherein the first surface texture comprises a chipseal texture, an asphalt texture, concrete striations, brushed finish, or aggregate finish.

19. The method of claim 16, wherein the first surface texture comprises a waffle texture, ribs, or raised or depressed dimples.
